(19) United States
(12) Patent Application Publication
(10) Pub. No.: US 2024/0141122 A1
(43) Pub. Date: May 2, 2024

(54) INSULATION LAYER-FORMING COMPOSITION

(71) Applicant: CATALER CORPORATION, Kakegawa-shi, Shizuoka (JP)

(72) Inventors: Takanori BABA, Kakegawa-shi (JP); Tetsuya KUME, Kakegawa-shi (JP); Yuki TAKAHASHI, Kakegawa-shi (JP); Kenta WATANABE, Kakegawa-shi (JP)

(73) Assignee: CATALER CORPORATION, Kakegawa-shi, Shizuoka (JP)

(21) Appl. No.: 18/279,716

(22) PCT Filed: Feb. 1, 2022
(86) PCT No.: PCT/JP2022/003875

§ 371 Date: Aug. 31, 2023

(30) Foreign Application Priority Data
Mar. 17, 2021 (JP) 2021-043347

(51) Int. Cl. C08J 7/04; C08J 7/02; C08K 3/22

(52) U.S. Cl. CPC C08J 7/0427; C08J 7/02; C08K 3/22; C08J 2327/16; C08K 2003/2227; C08K 2201/003

(57) ABSTRACT

An insulation layer forming-composition including boehmite, a binder, and an organic solvent, wherein when a thermogravimetric analysis is performed on the boehmite and measurement is conducted at a temperature elevation rate of 10° C./min under an air flow, the weight reduction percentage in a range of 200-450° C. is 10.0 mass % or less, and the weight reduction percentage in a range of 450-600° C. is 5.0-13.5 mass %.

### FIELD

The present invention relates to an insulation layer-forming composition.

### BACKGROUND

Secondary battery electrodes are provided with insulating layers for increased safety. For example, for a secondary battery using a non-aqueous electrolyte, it is known that forming an insulating layer covering the joining sections between the collectors of the electrodes and the active material layer prevents short circuiting (PTL 1).

The insulating layer can be formed using a coating paste comprising inorganic particles, a binder or its precursor, and a solvent. PTL 1, for example, describes a coating paste for formation of an insulating layer, comprising γ-alumina particles, a binder resin and an organic solvent. PTL 2 describes a coating solution for formation of an insulating layer, comprising boehmite, a bicarbonate, a crosslinked resin precursor and an organic solvent.

### CITATION LIST

### Patent Literature

[PTL 1] Japanese Unexamined Patent Publication No. 2012-074359
[PTL 2] International Patent Publication No. WO2013/136441

### SUMMARY

### Technical Problem

Publicly known coating pastes and coating solutions used to form insulating layers are associated with problems such as quality deterioration and variation in coating material viscosity over time. Publicly known coating pastes and coating solutions also comprise additives for increased coating material stability and are therefore costly.

It is an object of the invention to provide a coating composition for formation of an insulating film, which has stable quality and can be inexpensively produced.

### Solution to Problem

The present invention is as follows.

<Aspect 1> An insulation layer-forming composition comprising boehmite, a binder and an organic solvent,
wherein in thermogravimetric analysis of the boehmite under an air stream with a temperature-elevating rate of 10° C./min:
the weight reduction in a range of 200 to 450° C. is 10.0 mass % or lower, and
the weight reduction in a range of 450 to 600° C. is 5.0 mass % or greater and 13.5 mass % or lower.

<Aspect 2> The insulation layer-forming composition according to aspect 1, wherein the crystallite diameter (020) of the boehmite is 100 nm or greater and 750 nm or smaller.

<Aspect 3> The insulation layer-forming composition according to aspect 1 or 2, wherein the mean particle diameter D50 of the boehmite is 0.1 μm or larger and 5.0 μm or smaller.

<Aspect 4> The insulation layer-forming composition according to any one of aspects 1 to 3, wherein the binder is one or more selected from the group consisting of fluorine resins, polyimides and polyamideimides.

<Aspect 5> The insulation layer-forming composition according to aspect 4, wherein the binder includes polyvinylidene fluoride (PVDF).

<Aspect 6> The insulation layer-forming composition according to any one of aspects 1 to 5, wherein the organic solvent is an aprotic polar solvent.

<Aspect 7> The insulation layer-forming composition according to aspect 6, wherein the organic solvent includes N-methyl-2-pyrrolidone (NMP).

<Aspect 8> The insulation layer-forming composition according to any one of aspects 1 to 7, wherein the proportion of the mass of the binder with respect to the total mass of the boehmite and binder is 1 mass % or greater and 45 mass % or lower.

<Aspect 9> The insulation layer-forming composition according to any one of aspects 1 to 8, wherein the amount of organic solvent in the insulation layer-forming composition is 50 parts by mass or greater and 500 parts by mass or lower with respect to 100 parts by mass as the total of the boehmite and binder.

<Aspect 10> The insulation layer-forming composition according to any one of aspects 1 to 9, which is a composition for formation of an insulating layer for a battery.

<Aspect 11> A method for producing boehmite that is to be used in an insulation layer-forming composition according to any one of aspects 1 to 10, which includes:
heat treatment of boehmite at a temperature of 200° C. to 600° C.,
wherein in thermogravimetric analysis of the boehmite under an air stream with a temperature-elevating rate of 10° C./min:
the weight reduction in a range of 200 to 450° C. is greater than 10 mass %, or
the weight reduction in a range of 450 to 600° C. is greater than 13.5 mass %.

<Aspect 12> The method for producing boehmite according to aspect 11, wherein the heat treatment temperature is 400° C. or higher and 500° C. or lower.

### Advantageous Effects of Invention

The present invention provides a coating composition for formation of an insulating film with stable quality and reduced variation in viscosity with time. The coating composition of the invention does not need to comprise components other than the boehmite, binder and organic solvent to stabilize its quality, and therefore the coating composition of the invention can be produced at low cost.

### DESCRIPTION OF EMBODIMENTS

### <Insulation Layer-Forming Composition>

The insulation layer-forming composition of the invention comprises boehmite, a binder and an organic solvent,
wherein in thermogravimetric analysis of the boehmite under an air stream with a temperature-elevating rate of 10° C./min:
the weight reduction in a range of 200 to 450° C. is 10.0 mass % or lower, and
the weight reduction in a range of 450 to 600° C. is 5.0 mass % or greater and 13.5 mass % or lower.

### <Boehmite>

Boehmite is generally alumina monohydrate represented by the compositional formula: A100H. However, the boehmite of the invention also includes boehmite having a higher or a lower degree of hydration than the composition A100H.

As a requirement, the boehmite in the insulation layer-forming composition of the invention must satisfy conditions in thermogravimetric analysis of the boehmite under an air stream at a temperature-elevating rate of 10° C./min, specified as being a weight reduction of 10.0 mass % or lower in a range of 200 to 450° C., and a weight reduction of 5.0 mass % or greater and 13.5 mass % or lower in a range of 450 to 600° C.

### (Weight Reduction in Thermogravimetric Analysis)

That the weight reduction of the boehmite of the invention is 10.0 mass % or lower in the range of 200 to 450° C. means that the boehmite contains little hydration water that is easily dissociated. It is thought that satisfying this condition inhibits reaction of components in the insulation layer-forming composition with free water, and their consequent degradation.

That the weight reduction in the range of 450 to 600° C. is 5.0 mass % or greater presumably means that the boehmite contains a fixed amount of hydration water that is somewhat difficult to dissociate. It is thought that by satisfying this condition, the boehmite particles in the insulation layer-forming composition more readily form a solvate with the solvent, which is preferably an aprotic polar compound, helping to prevent reduction in viscosity of the insulation layer-forming composition by aggregation between the boehmite particles.

If the weight reduction in the range of 450 to 600° C. is 0, as in the case of alumina, then the particles will tend to undergo aggregation, causing reduction in viscosity of the insulation layer-forming composition.

If the weight reduction in the range of 450 to 600° C. is 13.5 mass % or lower, on the other hand, this means that the abundance of functional groups that are difficult to dissociate in the boehmite will be limited. It is thought that satisfying this condition can limit reaction between the functional groups and the binder, and inhibit degradation of the composition resulting from the reaction.

However, the present invention is not to be constrained by this theory.

From the viewpoint of lowering the amount of easily dissociated hydration water, the weight reduction in the range of 200 to 450° C. in thermogravimetric analysis of the boehmite is preferably lower, such as 8.0 mass % or lower, 5.0 mass % or lower, 3.0 mass % or lower, 2.5 mass % or lower, 2.0 mass % or lower, 1.5 mass % or lower, 1.0 mass % or lower, 0.5 mass % or lower or 0.3 mass % or lower, or even 0.1 mass % or lower or 0.0 mass %.

From the viewpoint of ensuring a fixed amount of hydration water that is somewhat difficult to dissociate, the weight reduction in the range of 450 to 600° C. in thermogravimetric analysis of the boehmite is preferably 6.0 mass % or greater, 7.0 mass % or greater, 8.0 mass % or greater, 9.0 mass % or greater, 10.0 mass % or greater, 11.0 mass % or greater or 12.0 mass % or greater, and 13.0 mass % or lower, 12.5 mass % or lower, 12.0 mass % or lower, 11.5 mass % or lower or 11.0 mass % or lower.

For thermogravimetric analysis of boehmite, a commercially available thermogravimetric analyzer may be used, weighing out about 10 mg of boehmite packed into a platinum pan as a sample, and carrying out analysis under an air stream with a flow rate of 200 mL/min, in a range of room temperature to 700° C. with a temperature-elevating rate of 10° C./min. The weight reduction in the range of 200 to 450° C. and the weight reduction in the range of 450 to 600° C. can each be calculated from the resulting TG chart.

### (Crystallite Diameter)

The crystallite diameter (020) of the boehmite in the insulation layer-forming composition of the invention may be 100 nm or larger and 750 nm or smaller.

The insulating film-forming composition of the invention exhibits excellent stability with time. If the crystallite diameter (020) of the boehmite is 100 nm or larger and 750 nm or smaller, then the stability of the insulating film-forming composition with time will be further improved, and in particular, reduction in the viscosity of the composition with time will be effectively inhibited.

The crystallite diameter (020) of the boehmite may be 200 nm or larger, 300 nm or larger, 400 nm or larger, 500 nm or larger or 600 nm or larger, and 700 nm or smaller, 650 nm or smaller, 600 nm or smaller, 550 nm or smaller or 500 nm or smaller.

The crystallite diameter of the boehmite can be calculated by the Scherrer equation represented as follows, using the half-width β of the peak at 20=14.48° corresponding to the (020) plane of boehmite as determined by XRD analysis, and using K=0.94.

D=Kλ/β cos θ

{In the formula, D represents the crystallite size, K represents the Scherrer constant, λ represents the wavelength of the X-rays, β represents the half-width, and θ represents the Bragg angle.}

The XRD analysis may be carried out under the following conditions, for example, using a commercially available X-ray diffractometer.
Line source: CuKα (wavelength: 1.5418A)
Tube voltage: 40 kV
Tube current: 250 mA
Scanning angle: 20=5 to 85°
Scanning rate: 4°/min

### (Mean Particle Diameter D50)

The mean particle diameter D50 of the boehmite in the insulation layer-forming composition of the invention is preferably larger from the viewpoint of increasing the electrical insulating property of the obtained insulating layer, while it is preferably smaller from the viewpoint of increasing the dispersibility of the boehmite in the insulation layer-forming composition.

Based on both of these viewpoints, the mean particle diameter D50 of the boehmite in the insulation layer-forming composition may be 0.1 μm or greater, 0.2 μm or greater, 0.3 μm or greater, 0.4 μm or greater, 0.5 μm or greater, 0.6 μm or greater, 0.7 μm or greater or 0.8 μm or greater, and 4.0 μm or smaller, 3.0 μm or smaller, 2.5 μm or smaller, 2.0 μm or smaller, 1.5 μm or smaller or 1.0 μm or smaller.

As used herein, the “mean particle diameter D50” may be the value determined as the particle diameter with a 50% cumulative volume fraction in the grain size distribution obtained by a laser light scattering method. The insulation layer-forming composition may optionally be provided for measurement of the particle size distribution after dilution with an appropriate solvent (such as NMP).

### (Specific Surface Area)

The specific surface area of the boehmite in the insulation layer-forming composition of the invention may be appropriately set from the viewpoint of both the electrical insulating property of the insulating layer to be obtained, and the dispersibility of the boehmite in the insulation layer-forming composition. From the same viewpoint, the specific surface area of the boehmite in the insulation layer-forming composition of the invention may be 1 m²/g or greater, 3 m²/g or greater, 5 m²/g or greater, 7 m²/g or greater, 10 m²/g or greater, 15 m²/g or greater or 20 m²/g or greater, and 150 m²/g or lower, 100 m²/g or lower, 80 m²/g or lower, 50 m²/g or lower, 30 m²/g or lower, 20 m²/g or lower, 15 m²/g or lower, 10 m²/g or lower or 8 m²/g or lower.

The specific surface area of the boehmite in the insulation layer-forming composition of the invention may be the value measured by the BET method using nitrogen as the adsorbate.

### <Binder>

The insulation layer-forming composition of the invention comprises a binder.

The binder in the insulation layer-forming composition of the invention may be one or more selected from the group consisting of fluorine resins, polyimides and polyamideimides, as examples.

Examples of fluorine resins include polytetrafluoroethylene (PTFE), tetrafluoroethylene-perfluoroalkoxyethylene copolymer (PFA), tetrafluoroethylene-hexafluoropropylene copolymer (FEP), tetrafluoroethylene-ethylene copolymer (ETFE), polyvinylidene fluoride (PVDF), polychlorotrifluoroethylene (PCTFE) and ethylene-chlorotrifluoroethylene copolymer (ECTFE).

The binder may include a fluorine resin or it may include PVDF, and most preferably it is composed of PVDF.

The proportion of the binder in the insulation layer-forming composition of the invention may be appropriately set in overall consideration of the stability of the composition with time, the electrical insulating property of the insulating layer to be obtained, and the mechanical strength of the insulating layer to be obtained. The proportion of the binder in the insulation layer-forming composition may be 1 mass % or greater, 5 mass % or greater, 10 mass % or greater, 15 mass % or greater or 20 mass % or greater, and 45 mass % or lower, 40 mass % or lower, 35 mass % or lower, 30 mass % or lower or 25 mass % or lower, as the mass proportion of the binder with respect to the total mass of the boehmite and binder.

### <Organic Solvent>

The solvent in the insulation layer-forming composition of the invention is an organic solvent. If the solvent of the insulation layer-forming composition is an organic solvent, it will be possible to maintain the amount of water absorbed by the binder without increase, which is advantageous from the viewpoint of storage stability of the insulation layer-forming composition.

The solvent in the insulation layer-forming composition of the invention may be an aprotic polar solvent from the viewpoint of increasing the dispersibility of the binder. The aprotic polar solvent may be selected from among N-methyl-2-pyrrolidone (NMP), N,N-dimethylformamide, triamide hexamethyl phosphate, dimethyl sulfoxide, acetonitrile, methyl acetamide and tetrahydrofuran, for example, and it may include NMP or be composed of NMP.

The amount of the organic solvent in the insulation layer-forming composition of the invention may be appropriately set in consideration of the coatability and storage stability of the insulation layer-forming composition.

The amount of organic solvent in the insulation layer-forming composition may be 50 parts by mass or greater, 100 parts by mass or greater, 150 parts by mass or greater, 200 parts by mass or greater, 250 parts by mass or greater or 300 parts by mass or greater, and 500 parts by mass or lower, 450 parts by mass or lower, 400 parts by mass or lower, 350 parts by mass or lower or 300 parts by mass or lower, with respect to 100 parts by mass as the total of the boehmite and binder.

### <Optional Components>

The insulation layer-forming composition of the invention may consist entirely of the boehmite, binder and organic solvent, or it may additionally comprise optional components. Examples of such other optional components include surfactants, viscosity modifiers, dispersing agents, coloring agents and antifoaming agents.

However, the insulation layer-forming composition of the invention exhibits the expected effect of the invention whether or not it comprises such optional components. Therefore, the insulation layer-forming composition of the invention essentially does not need to comprise optional components in addition to the boehmite, binder and organic solvent. That the insulation layer-forming composition essentially does not comprise optional components means that the mass proportion of optional components with respect to the total mass of the insulation layer-forming composition is 5 mass % or lower, 3 mass % or lower, 1 mass % or lower, 0.5 mass % or lower, 0.3 mass % or lower or 0.1 mass % or lower, and the value may even be 0 mass %.

### <Uses>

The insulation layer-forming composition of the invention is suitable for formation of an insulating layer for a printed board, multilayer circuit board, semiconductor device, display device or battery. The insulation layer-forming composition of the invention is especially suitable as a composition for formation of a battery insulating layer, and most optimal as a composition for formation of a secondary battery insulating layer.

### <Method for Producing Insulation Layer-Forming Composition>

The insulation layer-forming composition of the invention may be produced, for example, by mixing the specified boehmite, binder and organic solvent, and mixing them as a wet dispersion using an appropriate disperser.

The disperser used for wet dispersion may be appropriately selected from among publicly known devices. Examples of dispersers include ball mills, bead mills and planetary mixers.

Mixing and wet dispersion of the boehmite, binder and organic solvent can yield an insulation layer-forming composition with satisfactory dispersibility, essentially without altering the crystal system, crystallite diameter or specific surface area of the boehmite.

The mean particle diameter D50 of the boehmite will be slightly smaller even when mixed by wet dispersion. It is therefore suitable to adjust the mean particle diameter D50 of the boehmite starting material supplied for dispersion, to a slightly larger value than the specified value for the mean particle diameter D50 of the boehmite in the insulation layer-forming composition.

### <Method for Producing Boehmite>

According to the invention, the boehmite used exhibits a predetermined weight reduction in thermogravimetric analysis.

The boehmite used for the invention may be selected from among available sources, as one satisfying the conditions of the invention, or a starting material not satisfying the conditions of the invention may be used after adjusting its weight reduction in thermogravimetric analysis to the predetermined range.

According to another aspect, the present invention provides a method for producing boehmite to be used in the insulation layer-forming composition of the invention.

The method for producing boehmite of the invention includes:
heat treatment of boehmite at a temperature of 200° C. to 600° C.,
wherein in thermogravimetric analysis of the boehmite under an air stream with a temperature-elevating rate of 10° C./min:
the weight reduction in a range of 200 to 450° C. is greater than 10 mass %, or
the weight reduction in a range of 450 to 600° C. is greater than 13.5 mass %.

From the viewpoint of lowering weight reduction of the obtained boehmite in the range of 200 to 450° C., the heat treatment temperature may be higher than 200° C., or 250° C. or higher, 300° C. or higher, 350° C. or higher or 400° C. or higher. From the viewpoint of keeping the weight reduction of the obtained boehmite at 5.0 mass % or greater in the range of 450 to 600° C., the heat treatment temperature may be 460° C. or lower. The heat treatment temperature will typically be 400° C. or higher and 500° C. or lower.

The heat treatment time may be appropriately set in consideration of the weight reduction of the boehmite starting material, the desired weight reduction of the obtained boehmite, and the heat treatment temperature. The heat treatment time may be 10 minutes or longer, 20 minutes or longer, 30 minutes or longer, 45 minutes or longer or 1 hour or longer, and 12 hours or less, 8 hours or less, 6 hours or less, 4 hours or less, 3 hours or less, 2 hours or less or 1.5 hours or less.

The heat treatment atmosphere may be an oxidizing atmosphere, a reducing atmosphere or an inert atmosphere. The heat treatment will typically be carried out in air or in a nitrogen atmosphere.

### EXAMPLES

### <Thermogravimetric Analysis>

Thermogravimetric analysis of the boehmite was carried out using a commercially available thermogravimetric analyzer (model: “Thermo Plus EVO2” by Rigaku Corp.). After weighing out about 10 mg of boehmite and packing it into a platinum pan as a sample, measurement was conducted under an air stream with a flow rate of 200 mL/min, in a range of room temperature to 700° C. with a temperature-elevating rate of 10° C./min. The weight reduction in the range of 200 to 450° C. and the weight reduction in the range of 450 to 600° C. were each calculated from the resulting TG chart.

### <Xrd Analysis>

XRD analysis of the crystal system of the boehmite was carried out.

The crystallite diameter D of the boehmite was calculated by the Scherrer equation represented as follows, using the half-width β of the peak at 2θ=14.48° corresponding to the (020) plane of boehmite as determined by XRD analysis, and using K=0.94.

D=Kλ/13 cos θ

{In the formula, D represents the crystallite size, K represents the Scherrer constant, λ represents the wavelength of the X-rays, β represents the half-width, and θ represents the Bragg angle.} XRD analysis for determining the crystal system and crystallite diameter of the boehmite was carried out under the following conditions.
Measuring apparatus: Model: “RINT TTR III” by Rigaku Corp.
Line source: CuKα (wavelength: 1.5418A)
Tube voltage: 40 kV
Tube current: 250 mA
Scanning angle: 20=5 to 85°
Scanning rate: 4°/min

### <Specific Surface Area>

The specific surface area of the boehmite was measured by the BET method using nitrogen as the adsorbate.

### <Particle Diameter Measurement>

The mean particle diameter (D50) of the boehmite (or alumina) used to prepare the coating paste (insulation layer-forming composition) was determined as the particle diameter with a 50% cumulative volume fraction in the particle size distribution obtained by a laser light scattering method, with the powder dispersed in NMP being used as a sample. The measuring apparatus used was a “LA-960” by Horiba, Ltd., with 1.660 as the refractive index for boehmite and alumina, and 1.468 for NMP.

The mean particle diameter (D50) of the boehmite in the coating paste was measured by the same method described above, using the coating paste diluted with NMP as the sample.

### <Viscosity Measurement>

The viscosity of the coating paste was measured using an E-type viscometer, for both the initial viscosity immediately after preparation of the paste, and the post-storage viscosity after storing the coating paste in a sealed state for 4 days at a storage temperature of 60° C. The measuring conditions were as follows. Storage at 60° C. for 4 days is an accelerated test corresponding to storage at room temperature for 90 days.
Measuring apparatus: Model: “TVE-33H” by Toki Sangyo Co., Ltd.
Cone rotor type: 1° 34′×R24
Paste loading volume: −1 mL
Shear rate: 21.5 S⁻¹
Measuring temperature: 20° C.

The viscosity retention rate is the value of the post-storage viscosity divided by the initial viscosity, expressed as a percentage. In the Examples, a low viscosity retention rate indicates degradation of the quality of the coating paste.

### Example 1

After mixing 80 parts by mass of commercially available boehmite B1 as boehmite, 20 parts by mass of a polyvinylidene fluoride resin (PVDF) and 317 parts by mass of N-methylpyrrolidone (NMP), a large flow circulation-type bead mill (circulation mill) was used as a disperser for wet dispersion at a circulating flow rate of 10 L/min to obtain a coating paste (insulation layer-forming composition).

Table 1 shows the evaluation results for the boehmite used and the resulting coating paste, obtained by the methods described above.

### Example 2

A coating paste was obtained in the same manner as Example 1, except that the NMP content was changed to 257 parts by mass, the disperser used was a batch bead mill (batch mill) instead of a large flow circulation-type bead mill, the charging amount was 100 mL, and wet dispersion was carried out for 25 minutes. The evaluation results are shown in Table 1.

### Example 3

A coating paste was obtained in the same manner as Example 2, except that the boehmite used was commercially available boehmite B1, heat treated for 1 hour in air at 450° C. The evaluation results are shown in Table 1.

### Comparative Example 1

A coating paste was obtained in the same manner as Example 1, except that the boehmite used was 80 parts by mass of commercially available boehmite B2 instead of boehmite B1. The evaluation results are shown in Table 1.

### Example 4

A coating paste was obtained in the same manner as Comparative Example 1, except that the boehmite used was commercially available boehmite B2 heat treated for 1 hour in air at 475° C., the NMP content was changed to 257 parts by mass, and wet dispersion was carried out for 3 hours using a planetary mixer (P mixer) as the disperser, with a charging amount of approximately 500 mL. The evaluation results are shown in Table 1.

### Comparative Example 2

A coating paste was obtained in the same manner as Example 4, except that the boehmite used was commercially available boehmite B3, heat treated for 20 hours in air at 110° C., and the NMP content was changed to 317 parts by mass. The evaluation results are shown in Table 1.

### Comparative Example 3

A coating paste was obtained in the same manner as Example 4, except that commercially available alumina Al (α-alumina) was used instead of boehmite. The evaluation results are shown in Table 1.

TABLE 1

| | | | | | | Comp. | | Comp. | Comp. |
|---|---|---|---|---|---|---|---|---|---|
| | | | Exam- | Exam- | Exam- | Exam- | Exam- | Exam- | Exam- |
| | | | ple 1 | ple 2 | ple 3 | ple 1 | ple 4 | ple 2 | ple 3 |
| Boehmite | Type | | B1 | B1 | B1 | B2 | B2 | B3 | A1 |
| | Heat treatment | | Without | Without | 450° C., | Without | 475° C., | 110° C., | Without |
| | | | | | 1 h | | 1 h | 20 h | |
| | Thermogravimetric | 200 to 450° C. | 2.5 | 2.5 | 0.4 | 1.8 | 0.0 | 13.1 | 0.0 |
| | reduction rate (mass %) | 450 to 600° C. | 12.8 | 12.8 | 12.1 | 14.1 | 10.5 | 3.4 | 0.0 |

| | Crystal system | | Boehmite | Boehmite | Boehmite | Boehmite | Boehmite | Boehmite | α-alumina |
|---|---|---|---|---|---|---|---|---|---|
| | Crystallite diameter (020) (nm) | | 639 | 639 | 512 | 826 | 487 | 47 | — |
| | Mean particle diameter D50 (μm) | | 1.02 | 1.02 | 0.84 | 2.40 | 2.90 | 12.1 | 11.0 |
| | Specific surface area (m²/g) | | 6.4 | 6.4 | 11.8 | 3.4 | 21.4 | 190.3 | 4.6 |
| | Content (parts by mass) | | 80 | 80 | 80 | 80 | 80 | 80 | 80 |
| Binder | Type | | PVDF | PVDF | PVDF | PVDF | PVDF | PVDF | PVDF |
| | Content (parts by mass) | | 20 | 20 | 20 | 20 | 20 | 20 | 20 |
| Solvent | Type | | NMP | NMP | NMP | NMP | NMP | NMP | NMP |
| | Content (parts by mass) | | 317 | 257 | 257 | 317 | 257 | 317 | 257 |
| Disperser | | | Circula- | Batch | Batch | Circula- | P mixer | P mixer | P mixer |
| | | | tion | mill | mill | tion | | | |
| | | | mill | | | mill | | | |
| Coating | Solid concentration (mass %) | | 24 | 28 | 28 | 24 | 28 | 24 | 28 |
| material | Viscosity | Initial viscosity (mPa · s) | 1532 | 3842 | 4632 | 2200 | 7044 | 9488 | 6062 |
| paste | | Post-storage viscosity (mPa · s) | 1195 | 3045 | 4293 | 1534 | 6399 | 6142 | 4027 |
| | | Viscosity retention rate (%) | 78.0 | 79.3 | 92.7 | 69.7 | 90.8 | 64.7 | 66.4 |

The following conclusions are drawn from the Examples and Comparative Examples.

First, Comparative Example 2, which used boehmite with a weight reduction of 13.1 mass % in a range of 200 to 450° C., had a low viscosity retention rate of 64.7% after storage of the coating paste, whereas Examples 1 to 4 and Comparative Example 1, which used boehmite with a weight reduction of 10 mass % or lower in a range of 200 to 450° C., and Comparative Example 3 which used α-alumina with a value of 0 for the same, exhibited higher values than Comparative Example 2 for the viscosity retention rate of the coating paste. Furthermore, Examples 1 to 4, which used boehmite with a weight reduction of 5.0 mass % or greater and 13.5 mass % or lower in a range of 450 to 600° C., exhibited even higher values of 78% or greater for the viscosity retention rate of the coating paste. Examples 3 and 4 in particular, which used boehmite with a weight reduction of 10.0 mass % or greater and 12.5 mass % or lower in a range of 450 to 600° C., exhibited very high values exceeding 90% for the viscosity retention rate of the coating paste.

Based on comparison between Example 2 and Example 3 and between Comparative Example 1 and Example 4, it was confirmed that the viscosity retention rate of a coating paste can be improved by heating the boehmite and adjusting the weight reduction in the aforementioned temperature ranges.

In Comparative Example 3, however, which used α-alumina with a weight reduction of 0 in the range of 450 to 600° C., the viscosity retention rate of the coating paste after storage was 66.4%, which was slightly improved over the 64.7% of Comparative Example 2. This indicates that in order to improve the viscosity retention rate of the coating paste it is necessary for the weight reduction to be 5.0 mass % or greater in the range of 450 to 600° C.

It was further confirmed that an excellent viscosity retention rate is exhibited by a coating paste prepared using boehmite with a crystallite diameter (020) of 100 nm or greater and 750 nm or smaller and boehmite with a mean particle diameter D50 of 0.1 μm or greater and 5.0 μm or smaller.

### Analysis Examples

The mean particle diameters D50 of boehmite in the coating pastes prepared in Examples 1 and 2 and Comparative Example 1 were measured by the method described above. The results are shown in Table 2, together with the thermogravimetric reduction rates and powder mean particle diameters D50, and the viscosity retention rates of the coating pastes.

TABLE 2

| | | | | | Comp. |
|---|---|---|---|---|---|
| | | | Example 1 | Example 2 | Example 1 |
| Boehmite | Type | | B1 | B1 | B2 |
| | Heat treatment | | Without | Without | Without |
| | Thermogravimetric | 200 to 450° C. | 2.5 | 2.5 | 1.8 |
| | reduction rate (mass %) | 450 to 600° C. | 12.8 | 12.8 | 14.1 |

| | | | |
|---|---|---|---|
| Mean particle diameter D50 (μm) as powder | 1.02 | 1.02 | 2.40 |

| | | | |
|---|---|---|---|
| Disperser for coating paste preparation | Circulation | Batch | Circulation |
| | mill | mill | mill |
| Mean particle diameter D50 (μm) in coating paste | 0.63 | 0.63 | 2.11 |
| Viscosity retention rate (%) of coating paste | 78.0 | 79.3 | 69.7 |

1. An insulation layer-forming composition comprising boehmite, a binder and an organic solvent,
wherein in thermogravimetric analysis of the boehmite under an air stream with a temperature-elevating rate of 10° C./min:
the weight reduction in a range of 200 to 450° C. is 10.0 mass % or lower, and
the weight reduction in a range of 450 to 600° C. is 5.0 mass % or greater and 13.5 mass % or lower.

2. The insulation layer-forming composition according to claim 1, wherein the crystallite diameter (020) of the boehmite is 100 nm or greater and 750 nm or smaller.

3. The insulation layer-forming composition according to claim 1, wherein the mean particle diameter D50 of the boehmite is 0.1 μm or larger and 5.0 μm or smaller.

4. The insulation layer-forming composition according to claim 1, wherein the binder is one or more selected from the group consisting of fluorine resins, polyimides and polyamideimides.

5. The insulation layer-forming composition according to claim 4, wherein the binder includes polyvinylidene fluoride (PVDF).

6. The insulation layer-forming composition according to claim 1, wherein the organic solvent is an aprotic polar solvent.

7. The insulation layer-forming composition according to claim 6, wherein the organic solvent includes N-methyl-2-pyrrolidone (NMP).

8. The insulation layer-forming composition according to claim 1, wherein the proportion of the mass of the binder with respect to the total mass of the boehmite and binder is 1 mass % or greater and 45 mass % or lower.

9. The insulation layer-forming composition according to claim 1, wherein the amount of organic solvent in the insulation layer-forming composition is 50 parts by mass or greater and 500 parts by mass or lower with respect to 100 parts by mass as the total of the boehmite and binder.

10. The insulation layer-forming composition according to claim 1, which is a composition for formation of an insulating layer for a battery.

11. A method for producing boehmite that is to be used in an insulation layer-forming composition according to claim 1, which includes:
heat treatment of boehmite at a temperature of 200° C. to 600° C.,
wherein in thermogravimetric analysis of the boehmite under an air stream with a temperature-elevating rate of 10° C./min:
the weight reduction in a range of 200 to 450° C. is greater than 10 mass %, or
the weight reduction in a range of 450 to 600° C. is greater than 13.5 mass %.

12. The method for producing boehmite according to claim 11, wherein the heat treatment temperature is 400° C. or higher and 500° C. or lower.

13. The insulation layer-forming composition according to claim 1, wherein
the crystallite diameter (020) of the boehmite is 100 nm or greater and 750 nm or smaller, and
the mean particle diameter D50 of the boehmite is 0.1 μm or larger and 5.0 μm or smaller.

14. The insulation layer-forming composition according to claim 13, wherein the binder is one or more selected from the group consisting of fluorine resins, polyimides and polyamideimides.

15. The insulation layer-forming composition according to claim 14, wherein the binder includes polyvinylidene fluoride (PVDF).

16. The insulation layer-forming composition according to claim 13, wherein the proportion of the mass of the binder with respect to the total mass of the boehmite and binder is 1 mass % or greater and 45 mass % or lower.

17. The insulation layer-forming composition according to claim 14, wherein the proportion of the mass of the binder with respect to the total mass of the boehmite and binder is 1 mass % or greater and 45 mass % or lower.

18. The insulation layer-forming composition according to claim 15, wherein the proportion of the mass of the binder with respect to the total mass of the boehmite and binder is 1 mass % or greater and 45 mass % or lower.
